(19) United States
(12) Patent Application Publication
(10) Pub. No.: US 2011/0119744 A1
(43) Pub. Date: May 19, 2011

(54) PSEUDONYMOUS IDENTIFICATION MANAGEMENT APPARATUS, PSEUDONYMOUS IDENTIFICATION MANAGEMENT METHOD, PSEUDONYMOUS IDENTIFICATION MANAGEMENT SYSTEM AND SERVICE ADMISSION METHOD USING SAME SYSTEM

(75) Inventors: Sang Rae CHO, Daejeon (KR); Jin-Man CHO, Daejeon (KR); Young Seob CHO, Daejeon (KR); Dae Seon CHOI, Daejeon (KR); Jong-Hyouk NOH, Daejeon (KR); Soo Hyung KIM, Daejeon (KR); Seung-Hyun KIM, Daejeon (KR); Kwansoo JUNG, Daejeon (KR); DeokJin KIM, Daejeon (KR); Seung Hun JIN, Daejeon (KR)

(73) Assignee: Electronics and Telecommunications Research Institute, Daejeon (KR)

(21) Appl. No.: 12/874,555

(22) Filed: Sep. 2, 2010

(30) Foreign Application Priority Data
Nov. 18, 2009 (KR) 10-2009-0111359

(51) Int. Cl. H04L 9/32

(52) U.S. Cl. 726/6

(57) ABSTRACT

A pseudonymous ID (identification) management apparatus includes a token processing unit for validating an authentication token; a pseudonymous ID generation unit for issuing a pseudonymous ID corresponding to the authentication token; a temporary ID generation unit for issuing a temporary ID for use in an offline subscription; and an ID validation unit for validating a pseudonymous ID received from a web service apparatus along with a pseudonymous ID validation request and transmitting pseudonymous ID validation result to the web service apparatus, and validating a temporary ID received from the web service apparatus along with a pseudonymous ID exchange request and transmitting a pseudonymous ID corresponding to the temporary ID to the web service apparatus. The web service apparatus provides a service to which a user desires to subscribe.

### CROSS-REFERENCE(S) TO RELATED APPLICATION(S)

The present invention claims priority to Korean Patent Application No. 10-2009-0111359, filed on Nov. 18, 2009, which is incorporated herein by reference.

### FIELD OF THE INVENTION

The present invention relates to a pseudonymous ID (identification) management method and a service admission method using pseudonymous IDs; and, more particularly, to a pseudonymous ID management apparatus, a pseudonymous ID management method, a pseudonymous ID management system and a service admission method using the system, wherein public IDs of a private person are replaced with a pseudonymous ID appropriate for online and offline use.

### BACKGROUND OF THE INVENTION

As well known, public IDs, e.g., a resident registration number and a social security number, of a private person have been used for a long time because they have unique identification and convenience in management.

In particular, as information systems become to be generalized, public institutions and private cooperation have widely used such public IDs as identification and linking information to provide various services to private persons.

The residence registration numbers and social security numbers are not only used as means for identifying private persons but also used as other means on online and offline. Further, illegal drain of the residence registration numbers and social security numbers causes many problems because they cannot be reissued or modified.

In order to overcome the above-described problems of the residence registration numbers and social security numbers, various personal identification numbers on the Internet has been developed. However, the personal identification numbers have a drawback in that they can be used only in online environments.

### SUMMARY OF THE INVENTION

In view of the above, the present invention provides a pseudonymous ID management apparatus, a pseudonymous ID management method, a pseudonymous ID management system and a service admission method using the system, wherein public IDs of a private person are replaced with a pseudonymous ID appropriate for online and offline use.

In accordance with an aspect of the present invention, there is provided a pseudonymous ID (identification) management apparatus, including:

a token processing unit for validating, storing and managing an authentication token received from a pseudonymous ID client terminal;

a pseudonymous ID generation unit for generating and issuing a pseudonymous ID corresponding to the authentication token;

a temporary ID generation unit for generating and issuing a temporary ID in response to a temporary ID issuance request from the pseudonymous ID client terminal, the temporary ID being for use in an offline subscription; and

an ID validation unit for validating, when receiving a pseudonymous ID validation request from a web service apparatus, a pseudonymous ID received from the web service apparatus along with the pseudonymous ID validation request and transmitting pseudonymous ID validation result to the web service apparatus, and validating, when receiving a pseudonymous ID exchange request from the web service apparatus, a temporary ID received from the web service apparatus along with the pseudonymous ID exchange request and transmitting a pseudonymous ID corresponding to the temporary ID to the web service apparatus, the web service apparatus providing a service to which a user desires to subscribe.

The pseudonymous ID management apparatus may further include an ID lifecycle management unit for managing current status of the pseudonymous ID and the temporary ID, the current status including a generation stage, a modification stage and an extinction stage.

The pseudonymous ID management apparatus may further include an audit/log management unit for storing and managing processing records of the token processing unit, the pseudonymous ID generation unit, the temporary ID generation unit and the ID validation unit.

Preferably, the pseudonymous ID is issued based on a purpose of use and a grade.

Preferably, the authentication token and the temporary ID are issued by using a name and a social security number of the user.

In accordance with another aspect of the present invention, there is provided a pseudonymous ID management method of the pseudonymous ID management apparatus, including:

transmitting, in response to a pseudo ID issuance request from the pseudonymous ID client terminal, a guidance message on an authentication procedure to the pseudonymous ID client terminal;

validating an authentication token received from the pseudonymous ID client terminal, the authentication token having been issued according to the authentication procedure;

issuing, after said validating the authentication token, a pseudonymous ID and transmitting the pseudonymous ID to the pseudonymous ID client terminal; and

transmitting, in response to the pseudonymous ID validation request from the web service apparatus, the pseudonymous ID validation result to the web service apparatus.

Preferably, the pseudonymous ID is issued based on a purpose of use and a grade.

Preferably, the authentication token is issued by using a name and a social security number of the user.

In accordance with still another aspect of the present invention, there is provided a pseudonymous ID management method of the pseudonymous ID management apparatus, including:

issuing a temporary ID in response to the temporary ID issuance request from the pseudonymous ID client terminal and transmitting the temporary ID to the pseudonymous ID client terminal;

receiving the pseudonymous ID exchange request along with the temporary ID from the web service apparatus; and

transmitting a pseudonymous ID corresponding to the temporary ID to the web service apparatus.

Preferably, the pseudonymous ID is issued based on a purpose of use and a grade.

Preferably, the authentication token is issued by using a name and a social security number of the user.

In accordance with still another aspect of the present invention, there is provided a pseudonymous ID (identification) management system, including:

an authentication apparatus for issuing an authentication token;

a pseudonymous ID client terminal for transmitting a pseudonymous ID issuance request along with the authentication token; and

a pseudonymous ID management apparatus for issuing, after validating the authentication token received from the pseudonymous ID client terminal along with the pseudonymous ID issuance request, a pseudonymous ID and transmitting the pseudonymous ID to the pseudonymous ID client terminal.

The pseudonymous ID management system may further includes a web service apparatus for providing a service to which a user desires to subscribe. The pseudonymous ID client terminal transmits to the web service apparatus an online service subscription request along with the pseudonymous ID. The web service apparatus transmits a pseudonymous ID validation request along with the pseudonymous ID received from the pseudonymous ID client terminal to the pseudonymous ID management apparatus. The pseudonymous ID management apparatus validates the pseudonymous ID received from the web service apparatus and transmits pseudonymous ID validation result to the web service apparatus. The web service apparatus determines, based on the pseudonymous ID validation result, whether the pseudonymous ID received from the pseudonymous ID client terminal is valid or not and selectively admits the online subscription request.

The pseudonymous ID management system may further includes a web service apparatus for providing a service to which a user desires to subscribe; and an offline reception terminal for transmitting an offline service subscription request along with a temporary ID issued by the pseudonymous ID management apparatus to the web service apparatus. When receiving the offline service subscription request, the web service apparatus may transmit a pseudonymous ID exchange request along with the temporary ID to the pseudonymous ID management apparatus. In response to the pseudonymous ID exchange request, the pseudonymous ID management apparatus may validate the temporary ID and transmits a pseudonymous ID corresponding to the temporary ID to the web service apparatus. The web service apparatus may admit the offline service subscription request by using the pseudonymous ID received from the pseudonymous ID management apparatus.

Preferably, the pseudonymous ID is issued based on a purpose of use and a grade and the authentication token is issued by using a name and a social security number of a user.

In accordance with still another aspect of the present invention, there is provided a service admission method, including:

transmitting, at a pseudonymous ID management apparatus, an authentication guidance message to a pseudonymous ID client terminal in response to a pseudonymous ID issuance request received from the pseudonymous ID client terminal;

transmitting, at the pseudonymous ID client terminal, an authentication token having been issued according to the authentication guidance message;

validating, at the pseudonymous ID management apparatus, the authentication token received from the pseudonymous ID client terminal;

issuing, at the pseudonymous ID management apparatus, a pseudonymous ID and transmitting the pseudonymous ID to the pseudonymous ID client terminal;

transmitting, at the pseudonymous ID client terminal, an online subscription request along with the pseudonymous ID to a web service apparatus providing a service to which a user desires to subscribe;

transmitting, at the web service apparatus, a pseudonymous ID validation request along with the pseudonymous ID received from the pseudonymous ID client terminal to the pseudonymous ID management apparatus;

validating, at the pseudonymous ID management apparatus, the pseudonymous ID received from the web service apparatus and transmitting pseudonymous ID validation result to the web service apparatus; and

determining, at the web service apparatus, whether the pseudonymous ID received from the pseudonymous ID client terminal is valid based on the pseudonymous ID validation result and selectively admitting the online subscription request.

Preferably, the pseudonymous ID is issued based on a purpose of use and a grade.

Preferably, the authentication token is issued by using a name and a social security number of the user.

The service admission method may further include issuing, at the pseudonymous ID management apparatus, a temporary ID and transmitting the temporary ID to the pseudonymous ID client terminal; receiving, at the web service apparatus, the temporary ID along with an offline subscription request; transmitting, at the web service apparatus, a pseudonymous ID exchange request along with the temporary ID to the pseudonymous ID management apparatus; validating, at the pseudonymous ID management apparatus, the temporary ID and transmitting a pseudonymous ID corresponding to the temporary ID to the web service apparatus in response to the pseudonymous ID exchange request; and admitting, at the web service apparatus, the offline subscription request by using the pseudonymous ID received from the pseudonymous ID management apparatus.

Preferably, the authentication token is issued by using the name and the social security number of the user.

According to the present invention, the pseudonymous ID is generated and validated through a trustful organization and can be modified when necessary. Hence, the pseudonymous ID is prevented from including unnecessarily detailed private information of a user and being unintentionally generated by a third-party.

Further, since the pseudonymous ID supports anonymity, many problems, e.g., restriction and weakness in security and privacy, which might be caused when using public IDs, e.g., a social security number, in online and offline subscription can be solved.

Furthermore, since the pseudonymous ID can be reissued, damages due to an illegal drain of the public IDs can be decreased.

### BRIEF DESCRIPTION OF THE DRAWINGS

The above features of the present invention will become apparent from the following description of embodiments given in conjunction with the accompanying drawings, in which:

FIG. 1 illustrates a block diagram of a pseudonymous ID management system in accordance with an embodiment of the present invention;

FIG. 2 illustrates the pseudonymous ID management apparatus in the system of FIG. 1;

FIG. 3A illustrates a flowchart of a pseudonymous ID issuance procedure in the pseudonymous ID management apparatus of FIG. 1;

FIG. 3B illustrates a flowchart of an authentication token issuance procedure in the authentication apparatus of FIG. 1;

FIG. 4 illustrates a flowchart of an online service subscription procedure in the web service apparatus of FIG. 1;

FIG. 5A illustrates a flowchart of a temporary ID issuance procedure in the pseudonymous ID management apparatus of FIG. 1; and

FIG. 5B illustrates a flowchart of an offline service subscription procedure in the web service apparatus of FIG. 1.

### DETAILED DESCRIPTION OF THE EMBODIMENTS

Hereinafter, embodiments of the present invention will be described in detail with reference to the accompanying drawings, which form a part hereof.

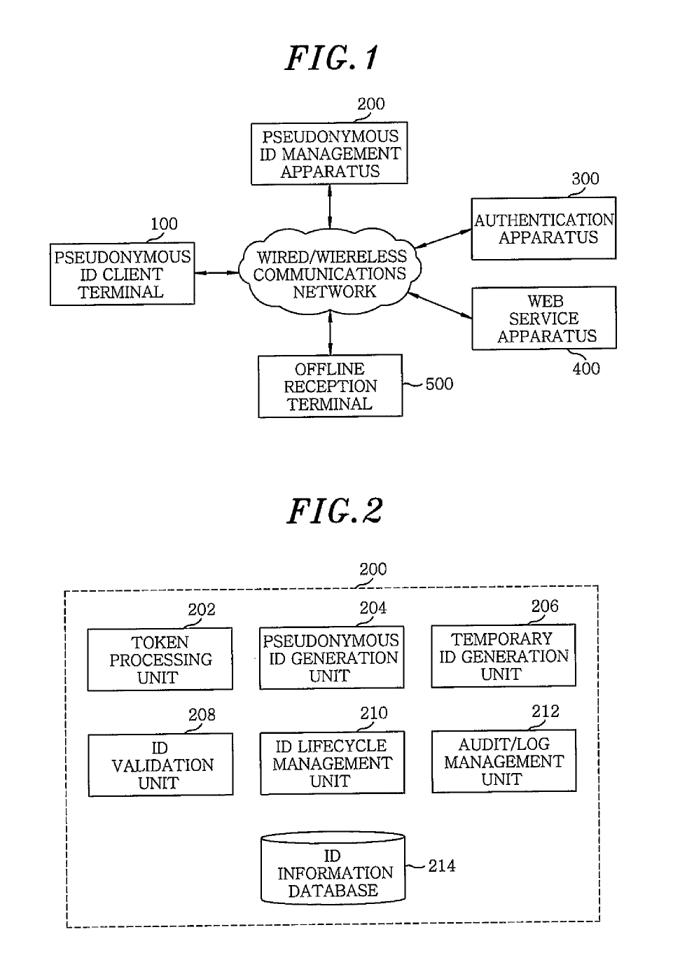

FIG. 1 illustrates a block diagram of a pseudonymous ID management system in accordance with an embodiment of the present invention.

The pseudonymous ID management system, which issues and manages a pseudonymous ID to provide various services, includes a pseudonymous ID client terminal 100, a pseudonymous ID management apparatus 200, an authentication apparatus 300, a web service apparatus 400, an offline reception terminal 500 and a wired/wireless communications network 600.

The pseudonymous ID client terminal 100 is a terminal device in which a client program is installed. The client program may be run on an Internet access program, e.g., a web browser.

When receiving an input from a user, the pseudonymous ID client terminal 100 accesses the pseudonymous ID management apparatus 200 to request an issuance of a pseudonymous ID, and according to authentication procedure guidance received from the pseudonymous ID management apparatus 200, accesses the authentication apparatus 300 via the wired/wireless communications network 600. In response to user authentication request from the authentication apparatus 300, the pseudonymous ID client terminal 100 receives from the user authentication information including, e.g., a name and a social security number of the user, and transmits thus received authentication information to the authentication apparatus 300 via the wired/wireless communications network 600.

When receiving from the authentication apparatus 300 an authentication token which is issued by the authentication apparatus 300 through validation of the authentication information, the pseudonymous ID client terminal 100 transmits the authentication token to the pseudonymous ID management apparatus 200, and then receives from the pseudonymous ID management apparatus 200 a pseudonymous ID which is issued by the pseudonymous ID management apparatus 200 though validation of the authentication token. The authentication token can be submitted to the pseudonymous ID management apparatus 200 and used as credentials for issuance of the pseudonymous ID at any time before an available time of the authentication token expires.

In case of online subscription, the pseudonymous ID client terminal 100 accesses the web service apparatus 400 via the wired/wireless communications network 600. When receiving the pseudonymous ID from the user, the pseudonymous ID client terminal 100 transmits an online subscription request along with thus received pseudonymous ID to the web service apparatus 400. The pseudonymous ID client terminal 100 receives from the web service apparatus 400 a guidance message on a pseudonymous ID validation or subscription result, and displays thus received guidance message.

In case of offline subscription, the pseudonymous ID client terminal 100 accesses the pseudonymous ID management apparatus 200 via the wired/wireless communications network 600 to request issuance of a temporary ID for use in the offline subscription, and then receives the temporary ID from the pseudonymous ID management apparatus 200. Thus received temporary ID is submitted to an offline reception desk by the user.

The pseudonymous ID management apparatus 200 includes a server for providing the pseudonymous ID and the temporary ID to the user. The pseudonymous ID management apparatus 200 issues the pseudonymous ID, manages lifecycle, e.g., generation, modification and extinction, of the IDs and validates the pseudonymous ID. When receiving a pseudonymous ID issuance request from the pseudonymous ID client terminal 100, the pseudonymous ID management apparatus 200 guides the pseudonymous ID client terminal 100 to access the authentication apparatus 300. When receiving from the pseudonymous ID client terminal 100 the authentication token issued by the authentication apparatus 300, the pseudonymous ID management apparatus 200 validates thus received authentication token, and then issues a temporary ID corresponding to thus validated authentication token and transmits the temporary ID to the pseudonymous ID client terminal 100. When necessary, the pseudonymous ID can be classified into various types based on a purpose of use, e.g., online banking and online shopping, a grade, e.g., the first grade and the second grade, and the like, and issued based on such classification.

In case of the online subscription, when receiving a pseudonymous ID validation request from the web service apparatus 400, the pseudonymous ID management apparatus 200 validate the pseudonymous ID and transmits validation result to the web service apparatus 400.

In case of the offline subscription, when receiving a temporary ID issuance request from the pseudonymous ID client terminal 100, the pseudonymous ID management apparatus 200 issues the temporary ID for use in the offline subscription and transmits the temporary ID to the pseudonymous Id client terminal 100. Thereafter, when receiving a pseudonymous ID exchange request along with the temporary ID from the web service apparatus 400, the pseudo ID management apparatus 200 transmits a pseudonymous ID corresponding to thus received temporary ID to the web service apparatus 400. The temporary ID can be issued by using, e.g., a name and a social security number of the user.

The authentication apparatus 300 includes a server for authenticating a user based on a public identification of the user, and issues the authentication token. When connected with the pseudonymous ID client terminal 100, the authentication apparatus 300 requests user authentication information, e.g., a name and a social security number of the user, of the pseudonymous ID client terminal 100. After validating the authentication information received from the pseudonymous ID client terminal 100.

The web service apparatus 400 includes a server for providing web services to the user, e.g., a web server and a web application server. When receiving an online subscription request along with a pseudonymous ID from the pseudonymous ID client terminal 100, the web service apparatus 400 requests the pseudonymous ID management apparatus 200 to validate thus received pseudonymous ID, and then receives validation result from the pseudonymous ID management apparatus 200. If the pseudonymous ID is invalid, the web service apparatus 400 transmits to the pseudonymous ID client terminal 100 a guidance message notifying that the pseudonymous ID is an invalid ID. Meanwhile, if the pseudonymous ID is valid, the web service apparatus 400 admits the online subscription and transmits a guidance message on subscription result to the pseudonymous ID client terminal 100.

Further, when receiving an offline subscription request along with a temporary ID from the offline reception terminal 500, the web service apparatus 400 transmits a pseudonymous ID exchange request along with thus received temporary ID to the pseudonymous ID management apparatus 200, and then receives a pseudonymous ID from the pseudonymous ID management apparatus 200. After receiving the pseudonymous ID, the web service apparatus 400 admits the offline subscription by using the pseudonymous ID and transmits a guidance message on subscription result to the offline reception terminal 500.

The offline reception terminal 500 receives subscription information from a user on offline, e.g., via a telephone call. The offline reception terminal 500 transmits an offline subscription request along with a temporary ID to the web service apparatus 400, and then receives subscription result from the web service apparatus 400.

The wired/wireless communications network 600 provides the pseudonymous ID client terminal 100, the pseudonymous ID management apparatus 200, the authentication apparatus 300, the web service apparatus 400 and the offline reception terminal 500 with communications environment allowing them to communicate with each other.

The wired/wireless communications network 600 may be a wired TCP/IP (Transmission Control Protocol/Internet Protocol) network on which various upper layer services, e.g., HTTP (Hyper-Text Transfer Protocol), Telnet (Teletype Network), FTP (File Transfer Protocol), DNS (Domain Name Service), SMTP (Simple Mail Transfer Protocol), SNMP (Simple Network Management Protocol), NFS (Network File Service) and NIS (Network Information Service), can be implemented.

Also, the wired/wireless communications network 600 may be a synchronous or asynchronous wireless communications network, e.g., a CDMA (Code Division Multiple Access) or GSM (Global System for Mobile communications) network and other next generation mobile communications networks, having base stations and base station controllers to perform handover procedures and wireless resource management.

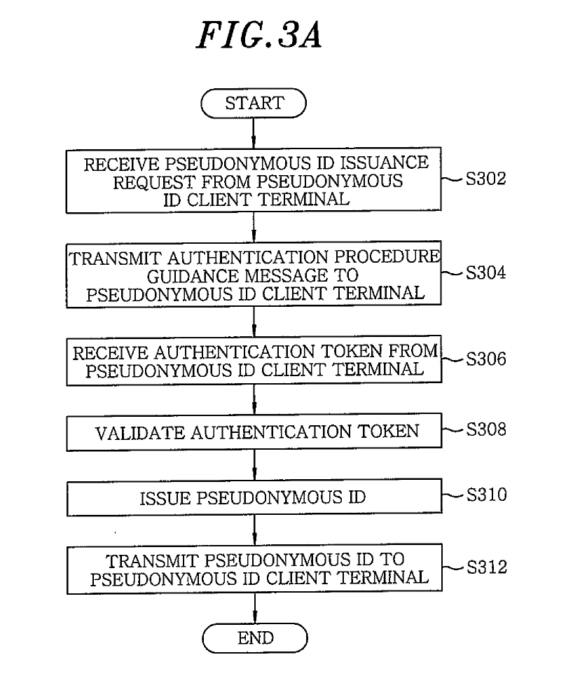

FIG. 2 illustrates the pseudonymous ID management apparatus 200 in the system of FIG. 1. Below, details of the pseudonymous ID management apparatus 200 will be described with reference to FIG. 2.

The pseudonymous ID management apparatus 200 includes a token processing unit 202, a pseudonymous ID generation unit 204, a temporary ID generation unit 206, an ID validation unit 208, an ID lifecycle management unit 210, an audit/log management unit 212 and an ID information database 214.

The token processing unit 202 validates, stores and manages the authentication token issued by the authentication apparatus 300. When receiving from the pseudonymous ID client terminal 100 an authentication token for use in an issuance of a pseudonymous ID, the token processing unit 202 validates thus received authentication token and stores the authentication token in the ID information database 214, thereby managing the authentication token.

The pseudonymous ID generation unit 204 generates, by using a random number generation algorithm, a pseudonymous ID having uniqueness and being conflict-free with other pseudonymous IDs. After the token processing unit 202 validates the authentication token received from the pseudonymous ID client terminal 100, the pseudonymous ID generation unit 204 generates and issues a pseudonymous ID corresponding to thus validated authentication token and transmits the pseudonymous ID to the pseudonymous ID client terminal 100. As described above, when necessary, the pseudonymous ID can be classified into various types based on a purpose of use, e.g., online banking and online shopping, a grade, e.g., the first grade and the second grade, and the like, and issued based on such classification.

The temporary ID generation unit 206 generates a temporary ID for use in the offline subscription. The temporary ID is exchanged with a pseudonymous ID and may have a length, e.g., below twenty characters, such that a user can readily write the temporary ID on a note and the temporary ID can be processed easily. When receiving a temporary ID issuance request from the pseudonymous ID client terminal 100, the temporary ID generation unit 206 generates and issues a temporary ID, and transmits the temporary ID to the pseudonymous ID client terminal 100.

The ID validation unit 208 validates the pseudonymous ID and the temporary ID. When receiving a pseudonymous ID validation request or a temporary ID validation request from the web service apparatus 400, the ID validation unit 208 checks whether or not an available time of the ID expires and whether or not the ID is rightly issued by the pseudonymous ID management apparatus 200, and then transmits validation result of the ID to the web service apparatus 400.

The ID lifecycle management unit 210 manages current status of the already issued pseudonymous or temporary ID. The current status of an ID is lifecycle information indicating to which stage the ID currently belongs among several stages, e.g., generation, modification and extinction, in a lifecycle of the ID. The issued pseudonymous or temporary ID is stored in the ID information database 214, and when a change occurs in the current status of the ID, a storing location of the ID in the ID information database 214 can be also changed.

The audit/log management unit 212 records and stores in the ID information database 214 audits and logs for operation results of the units 202 to 212 in the pseudonymous ID management apparatus 200. Thus stored audits and logs serve as data for use in solving security or privacy problems which might occur in the future.

The ID information database 214 stores therein the pseudonymous IDs, the temporary IDs, the authentication tokens, the validation results, the lifecycle information of the IDs, the audits and the logs. When necessary, data stored in the ID information database 214 can be extracted therefrom and transmitted to other elements of the system.

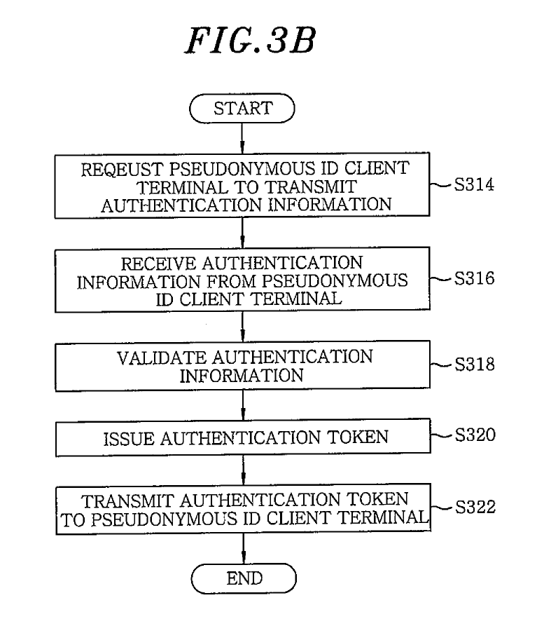

Below, a pseudonymous ID issuance procedure by using an authentication token will be described with reference to FIGS. 3A and 3B.

FIG. 3A illustrates a flowchart of the pseudonymous ID issuance procedure in the pseudonymous ID management apparatus 200 of FIG. 1.

As shown in FIG. 3A, the pseudonymous ID client terminal 100 accesses the pseudonymous ID management apparatus 200 via an Internet access program, e.g., a web browser, to request an issuance of a pseudonymous ID.

The pseudonymous ID management apparatus 200 receives a pseudonymous ID issuance request from the pseudonymous ID client terminal 100 (step S302). In response to the pseudonymous ID issuance request, the pseudonymous ID management apparatus 200 transmits a guidance message on the authentication token issuance procedure to the pseudonymous ID client terminal 100 (step S304). The guidance message may include web site information through which the pseudonymous ID client terminal 100 can access the authentication apparatus 300. According to the guidance message received from the pseudonymous ID management apparatus 200, the pseudonymous ID client terminal 100 accesses the authentication apparatus 300 and then the authentication token issuance procedure is carried out.

FIG. 3B illustrates a flowchart of the authentication token issuance procedure in the authentication apparatus 300 of FIG. 1.

As shown in FIG. 3B, the authentication apparatus 300 transmits a user authentication information request to the pseudonymous ID client terminal 100 (S314). In response to the authentication information request, the pseudonymous ID client terminal 100 transmits the authentication information including, e.g., a user's name, a social security number of the user and an ID and password linked with the social security number, and then the authentication apparatus 300 receives the authentication information from the pseudonymous ID client terminal 100 (S316).

The authentication apparatus 300 validates thus received authentication information (step S318), and issues an authentication token corresponding to the validated authentication information (step S320). The authentication token may have a linkage ID serving as a guarantee of the user authentication for the pseudonymous ID management apparatus 200, and the pseudonymous ID management apparatus 200 can use the linkage ID in identifying the user authenticated by the authentication apparatus 300.

The authentication apparatus 300 transmits thus issued authentication token to the pseudonymous ID client terminal 100 (step 5322) and then the authentication token issuance procedure is completed.

Referring back to FIG. 3A, the pseudonymous ID management apparatus 200 receives the authentication token from the pseudonymous ID client terminal 100 (step S306), and validates thus received authentication token (step S308). When completing the validation, the pseudonymous ID management apparatus 200 issues a pseudonymous ID corresponding to the authentication token (step S310). When necessary, the pseudonymous ID can be classified into various types based on a purpose of use, e.g., online banking and online shopping, a grade, e.g., the first grade and the second grade, and the like, and issued based on such classification.

The pseudonymous ID management apparatus 200 transmits thus issued pseudonymous ID to the pseudonymous ID client terminal 100 (step S312).

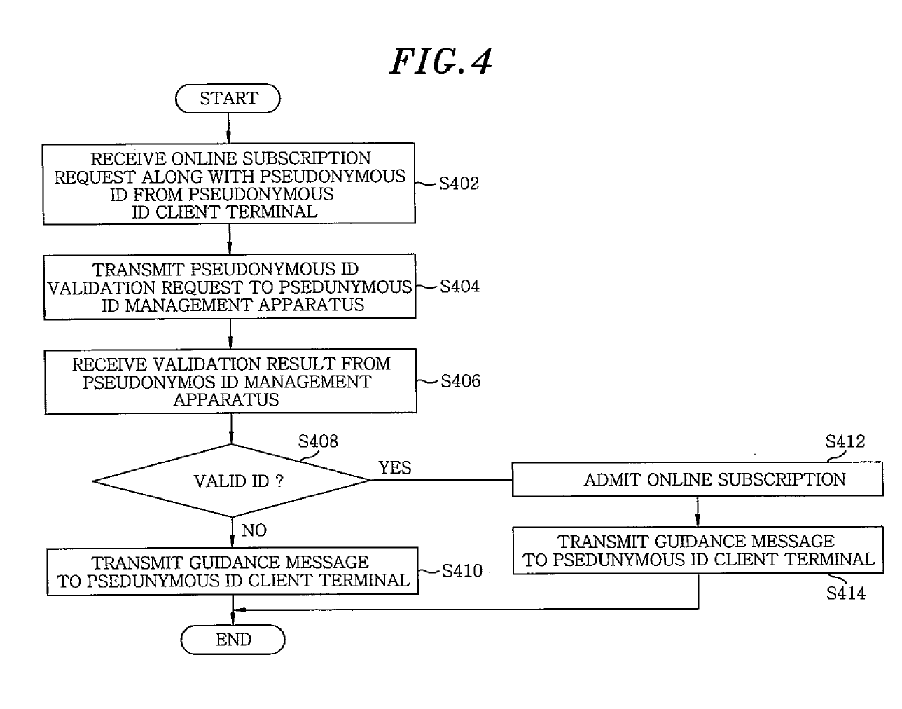

Below, an online service subscription procedure to a specific service provided by the web service apparatus 400 will be described with reference FIG. 4.

FIG. 4 illustrates a flowchart of an online service subscription procedure in the web service apparatus 400 of FIG. 1.

The web service apparatus 400 receives an online subscription request along with a pseudonymous ID from the pseudonymous ID client terminal 100 (step S402).

The web service apparatus 400 transmits the pseudonymous ID received from the pseudonymous ID client terminal 100 to the pseudonymous ID management apparatus 200 to request validation of the pseudonymous ID (step S404).

The pseudonymous ID management apparatus 200 validates the pseudonymous ID received from the web service apparatus 200, and then the web service apparatus 400 receives the validation result from the pseudonymous ID management apparatus 200 (step S406).

Based on the validation result received from the pseudonymous ID management apparatus 200, the pseudonymous ID management apparatus 200 determines whether the pseudonymous ID received from the pseudonymous ID client terminal 100 is valid or not (step S408).

If it is determined in the step 5408 that the pseudonymous ID is invalid, the web service apparatus 400 transmits to the pseudonymous ID client terminal 100 a guidance message notifying that the pseudonymous ID is an invalid ID (step S410). The pseudonymous ID client terminal 100 displays the guidance message received from the web service apparatus 400 in the step 5410.

Meanwhile, if it is determined in the step 5408 that the pseudonymous ID is valid, the web service apparatus 400 admits the online subscription of the user to the specific service (step 5412) and transmits to the pseudonymous ID client terminal 100 a guidance message notifying that the online subscription is admitted (step S414). The pseudonymous ID client terminal 100 displays the guidance message received from the web service apparatus 400 in the step 5414.

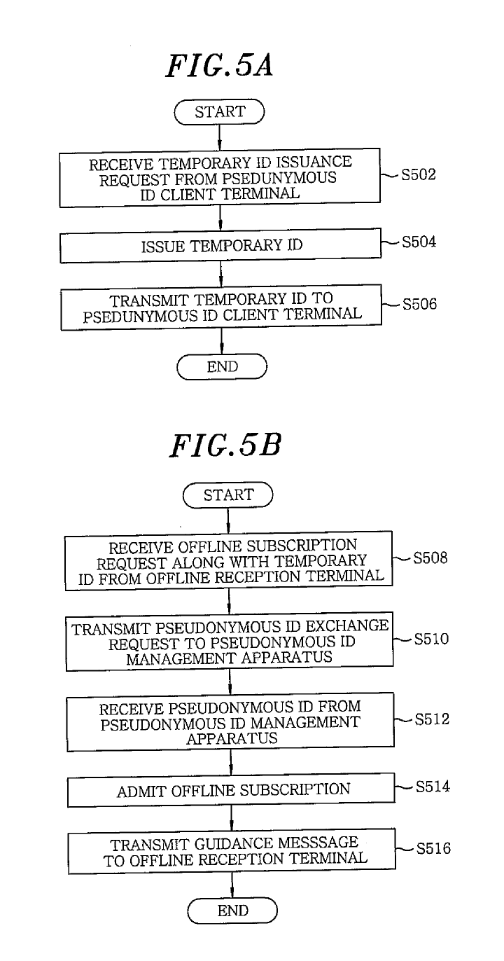

Below, an offline service subscription procedure to a specific service provided by the web service apparatus 400 by using a temporary ID will be described with reference FIGS. 5A and 5B.

FIG. 5A illustrates a flowchart of a temporary ID issuance procedure in the pseudonymous ID management apparatus 200 of FIG. 1.

The pseudonymous ID management apparatus 200 receives a temporary ID issuance request from the pseudonymous ID client terminal 100 (step S502).

In response to the temporary ID issuance request, the pseudonymous ID management apparatus 200 issues a temporary ID (step 5504) and transmits thus issued temporary ID to the pseudonymous ID client terminal 100 (step S506).

For the offline subscription, the user submits the temporary ID issued by the pseudonymous ID management apparatus 200 to an offline reception desk via, e.g., a telephone call, and the temporary ID is input to the offline reception terminal 500.

FIG. 5B illustrates a flowchart of an offline service subscription procedure in the web service apparatus 400 of FIG. 1.

The web service apparatus 400 receives an offline subscription request along with the temporary ID from the offline reception terminal 500 (step S508).

The web service apparatus 400 transmits a pseudonymous ID exchange request along with the temporary ID received from the offline reception terminal 500 to the pseudonymous ID management apparatus 200 (step S510).

In response to the pseudonymous ID exchange request, the pseudonymous ID management apparatus 200 transmits a pseudonymous ID corresponding to the temporary ID, and the web service apparatus 400 receives the pseudonymous ID from the pseudonymous ID management apparatus 200 (step S512).

The web service apparatus 400 admits the offline subscription of the user to the specific service by using the pseudonymous ID received from the pseudonymous ID management apparatus 200 (step 5514) and transmits to the offline reception terminal 500 a guidance message notifying that the offline subscription is admitted (step S516). The offline reception terminal 500 displays the guidance message received from the web service apparatus 400 in the step 5516 and reports the offline subscription result to the user.

Instead of the temporary ID issued by the pseudonymous ID management apparatus 200, an OTP (One Time Password) can be used for the offline subscription. In the OTP, information is shared between the pseudonymous ID client terminal 100 and the pseudonymous ID management apparatus 200, and both of time and event synchronization is performed therebetween.

While the invention has been shown and described with respect to the embodiments, it will be understood by those skilled in the art that various changes and modification may be made without departing from the scope of the invention as defined in the following claims.

What is claimed is:

1. A pseudonymous ID (identification) management apparatus, comprising:
a token processing unit for validating, storing and managing an authentication token received from a pseudonymous ID client terminal;
a pseudonymous ID generation unit for generating and issuing a pseudonymous ID corresponding to the authentication token;
a temporary ID generation unit for generating and issuing a temporary ID in response to a temporary ID issuance request from the pseudonymous ID client terminal, the temporary ID being for use in an offline subscription; and
an ID validation unit for validating, when receiving a pseudonymous ID validation request from a web service apparatus, a pseudonymous ID received from the web service apparatus along with the pseudonymous ID validation request and transmitting pseudonymous ID validation result to the web service apparatus, and validating, when receiving a pseudonymous ID exchange request from the web service apparatus, a temporary ID received from the web service apparatus along with the pseudonymous ID exchange request and transmitting a pseudonymous ID corresponding to the temporary ID to the web service apparatus, the web service apparatus providing a service to which a user desires to subscribe.

2. The pseudonymous ID management apparatus of claim 1, further comprising:
an ID lifecycle management unit for managing current status of the pseudonymous ID and the temporary ID, the current status including a generation stage, a modification stage and an extinction stage.

3. The pseudonymous ID management apparatus of claim 1, further comprising:
an audit/log management unit for storing and managing processing records of the token processing unit, the pseudonymous ID generation unit, the temporary ID generation unit and the ID validation unit.

4. The pseudonymous ID management apparatus of claim 1, wherein the pseudonymous ID is issued based on a purpose of use and a grade.

5. The pseudonymous ID management apparatus of claim 4, wherein the authentication token and the temporary ID are issued by using a name and a social security number of the user.

6. A pseudonymous ID management method of the pseudonymous ID management apparatus of claim 1, comprising:
transmitting, in response to a pseudo ID issuance request from the pseudonymous ID client terminal, a guidance message on an authentication procedure to the pseudonymous ID client terminal;
validating an authentication token received from the pseudonymous ID client terminal, the authentication token having been issued according to the authentication procedure;
issuing, after said validating the authentication token, a pseudonymous ID and transmitting the pseudonymous ID to the pseudonymous ID client terminal; and
transmitting, in response to the pseudonymous ID validation request from the web service apparatus, the pseudonymous ID validation result to the web service apparatus.

7. The pseudonymous ID management method of claim 6, wherein the pseudonymous ID is issued based on a purpose of use and a grade.

8. The pseudonymous ID management method of claim 6, wherein the authentication token is issued by using a name and a social security number of the user.

9. A pseudonymous ID management method of the pseudonymous ID management apparatus of claim 1, comprising:
issuing a temporary ID in response to the temporary ID issuance request from the pseudonymous ID client terminal and transmitting the temporary ID to the pseudonymous ID client terminal;
receiving the pseudonymous ID exchange request along with the temporary ID from the web service apparatus; and
transmitting a pseudonymous ID corresponding to the temporary ID to the web service apparatus.

10. The pseudonymous ID management method of claim 9, wherein the pseudonymous ID is issued based on a purpose of use and a grade.

11. The pseudonymous ID management method of claim 9, wherein the authentication token is issued by using a name and a social security number of the user.

12. A pseudonymous ID (identification) management system, comprising:
an authentication apparatus for issuing an authentication token;
a pseudonymous ID client terminal for transmitting a pseudonymous ID issuance request along with the authentication token; and
a pseudonymous ID management apparatus for issuing, after validating the authentication token received from the pseudonymous ID client terminal along with the pseudonymous ID issuance request, a pseudonymous ID and transmitting the pseudonymous ID to the pseudonymous ID client terminal.

13. The pseudonymous ID management system of claim 12, further comprising:
a web service apparatus for providing a service to which a user desires to subscribe,
wherein the pseudonymous ID client terminal transmits to the web service apparatus an online service subscription request along with the pseudonymous ID;
wherein the web service apparatus transmits a pseudonymous ID validation request along with the pseudonymous ID received from the pseudonymous ID client terminal to the pseudonymous ID management apparatus;
wherein the pseudonymous ID management apparatus validates the pseudonymous ID received from the web service apparatus and transmits pseudonymous ID validation result to the web service apparatus; and
wherein the web service apparatus determines, based on the pseudonymous ID validation result, whether the pseudonymous ID received from the pseudonymous ID client terminal is valid or not and selectively admits the online subscription request.

14. The pseudonymous ID management system of claim 12, further comprising:
a web service apparatus for providing a service to which a user desires to subscribe; and
an offline reception terminal for transmitting an offline service subscription request along with a temporary ID issued by the pseudonymous ID management apparatus to the web service apparatus,
wherein when receiving the offline service subscription request, the web service apparatus transmits a pseudonymous ID exchange request along with the temporary ID to the pseudonymous ID management apparatus;
wherein in response to the pseudonymous ID exchange request, the pseudonymous ID management apparatus validates the temporary ID and transmits a pseudonymous ID corresponding to the temporary ID to the web service apparatus; and
wherein the web service apparatus admits the offline service subscription request by using the pseudonymous ID received from the pseudonymous ID management apparatus.

15. The pseudonymous ID management system of claim 12, wherein the pseudonymous ID is issued based on a purpose of use and a grade and the authentication token is issued by using a name and a social security number of a user.

16. A service admission method, comprising:
transmitting, at a pseudonymous ID management apparatus, an authentication guidance message to a pseudonymous ID client terminal in response to a pseudonymous ID issuance request received from the pseudonymous ID client terminal;
transmitting, at the pseudonymous ID client terminal, an authentication token having been issued according to the authentication guidance message;
validating, at the pseudonymous ID management apparatus, the authentication token received from the pseudonymous ID client terminal;
issuing, at the pseudonymous ID management apparatus, a pseudonymous ID and transmitting the pseudonymous ID to the pseudonymous ID client terminal;
transmitting, at the pseudonymous ID client terminal, an online subscription request along with the pseudonymous ID to a web service apparatus providing a service to which a user desires to subscribe;
transmitting, at the web service apparatus, a pseudonymous ID validation request along with the pseudonymous ID received from the pseudonymous ID client terminal to the pseudonymous ID management apparatus;
validating, at the pseudonymous ID management apparatus, the pseudonymous ID received from the web service apparatus and transmitting pseudonymous ID validation result to the web service apparatus; and
determining, at the web service apparatus, whether the pseudonymous ID received from the pseudonymous ID client terminal is valid based on the pseudonymous ID validation result and selectively admitting the online subscription request.

17. The service admission method of claim 16, wherein the pseudonymous ID is issued based on a purpose of use and a grade.

18. The service admission method of claim 16, wherein the authentication token is issued by using a name and a social security number of the user.

19. The service admission method of claim 16, further comprising:
issuing, at the pseudonymous ID management apparatus, a temporary ID and transmitting the temporary ID to the pseudonymous ID client terminal;
receiving, at the web service apparatus, the temporary ID along with an offline subscription request;
transmitting, at the web service apparatus, a pseudonymous ID exchange request along with the temporary ID to the pseudonymous ID management apparatus;
validating, at the pseudonymous ID management apparatus, the temporary ID and transmitting a pseudonymous ID corresponding to the temporary ID to the web service apparatus in response to the pseudonymous ID exchange request; and
admitting, at the web service apparatus, the offline subscription request by using the pseudonymous ID received from the pseudonymous ID management apparatus.

20. The service admission method of claim 19, wherein the authentication token is issued by using the name and the social security number of the user.
